(19) United States
(12) Patent Application Publication
(10) Pub. No.: US 2024/0160691 A1
(43) Pub. Date: May 16, 2024

(54) NETWORK SWITCH AND METHOD WITH MATRIX AGGREGATION

(71) Applicants: SAMSUNG ELECTRONICS CO., LTD., Suwon-si (KR); UIF (University Industry Foundation), Yonsei University, Seoul (KR)

(72) Inventors: Ho Young KIM, Suwon-si (KR); Min Sik KIM, Seoul (KR); Won Woo RO, Seoul (KR); Se Hyun YANG, Suwon-si (KR)

(73) Assignees: SAMSUNG ELECTRONICS CO., LTD., Suwon-si (KR); UIF (University Industry Foundation), Yonsei University, Seoul (KR)

(21) Appl. No.: 18/316,611

(22) Filed: May 12, 2023

(30) Foreign Application Priority Data
Nov. 16, 2022 (KR) 10-2022-0153650

(51) Int. Cl. G06F 17/16; G06F 16/22

(52) U.S. Cl. CPC G06F 17/16; G06F 16/2237

(57) ABSTRACT

A method of operating a network switch for collective communication includes: receiving, via a network from external electronic devices, a first and second matrix each formatted according to a sparse matrix storage format; and generating a third matrix formatted according to the sparse matrix storage format, wherein the third matrix is generated by combining the first and second matrix according to the sparse matrix storage format, wherein, according to the sparse matrix storage format the first matrix includes first matrix positions of respective first element values and the second matrix includes second matrix positions of respective second element values, and wherein the combining includes comparing the first matrix positions with the second matrix positions.

### CROSS-REFERENCE TO RELATED APPLICATIONS

This application claims the benefit under 35 USC § 119(a) of Korean Patent Application No. 10-2022-0153650, filed on Nov. 16, 2022, in the Korean Intellectual Property Office, the entire disclosure of which is incorporated herein by reference for all purposes.

### BACKGROUND

### 1. Field

The following description relates to a network switch and method with matrix aggregation.

### 2. Description of Related Art

An artificial intelligence (AI) application may learn using a multi-node environment through an interface, such as a message passing interface (MPI).

In the multi-node environment, a network switch may improve the learning speed of the AI application by performing collective communication through a scalable hierarchical aggregation and reduction protocol (SHARP). The SHARP protocol may be efficient to process all-reduce (perform reduction) of collective communication.

The above description is information the inventor(s) acquired during the course of conceiving the present disclosure, or already possessed at the time, and is not necessarily art publicly known before the present application was filed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a network switch for collective communication, the network switch includes: one or more processors electrically connected with a memory; the memory storing instructions configured to, when executed by the one or more processors, cause the one more processors to: receive first and second matrices via a network from respective external electronic devices, the first and second matrices each having a sparse matrix storage format; and generate a third matrix in the sparse matrix storage format from the received first and second matrices by aggregating the received first and second matrices into the third matrix according to the sparse matrix storage format.

The generating may include: comparing a first position of a first element in the first matrix having a non-zero data value to a second position of a second element in the second matrix having a non-zero data value; and generating the third matrix from the first matrix and the second matrix based on a result of comparing the first position and the second position.

The comparing of the first position to the second position may include comparing a first row position value of the first position to a second row position value of the second position, and wherein the generating the third sparse matrix is based on a result of comparing the first row position value and the row second position value.

The comparing of the first position to the second position may further include, when the row first position value is the same as the second row position value, comparing a first column position value of the first position to a second column position value of the second position, and wherein the generating of the third matrix is based on result of comparing the first column position value and the second column position value.

The generating of the third matrix may include copying, to the third matrix, a data value of the element having the smaller row position value among the first row position value and the second row position value.

The generating the third matrix based on the result of comparing the first column position value and the second column position value may include: when the first column position value is different from the second column position value, copying a data value of the element having the smaller column position value among the first column position value and the second column position value; and when the first column position value is the same as the second column position value, adding the data value of the first element to the data value of the second element.

The instructions may be further configured to cause the one or more processors to: transmit the generated matrix via the network to one of the external electronic devices.

The sparse matrix storage format may include a coordinate list (COO) format, a compressed sparse row (CSR) format, and an ellpack (ELL) format, a list of lists (LIL) format, or a diagonal (DIA) format).

The first position may include a row index of the first element, a column index of the first element, or a row offset for the first element.

In another general aspect, a method of operating a network switch for collective communication includes: receiving, via a network from external electronic devices, a first and second matrix each formatted according to a sparse matrix storage format; and generating a third matrix formatted according to the sparse matrix storage format, wherein the third matrix is generated by combining the first and second matrix according to the sparse matrix storage format, wherein, according to the sparse matrix storage format the first matrix includes first matrix positions of respective first element values and the second matrix includes second matrix positions of respective second element values, and wherein the combining includes comparing the first matrix positions with the second matrix positions.

The generating may include: comparing a first matrix position of a first element value to a second matrix position of a second element value; and based on the first matrix position and the second matrix position being equal, adding to the third matrix, as a new matrix position thereof, the first or second matrix position, and adding, as a new element value of the new matrix position of the third matrix, a sum of the first element value and the second element value.

The comparing of the first matrix position to the second matrix position may include comparing a first row position value of the first matrix position to a second row position value of the second matrix position, and wherein the generating the third matrix is based on a result of comparing the first row position value and the second row position value.

The method may further include, when the first row position value is the same as the second row position value, comparing a first column position value of the first matrix position a second column position value of the second matrix position, and wherein the generating the third matrix may be based on a result of the comparing of the first column position value and the second column position value.

The generating of the third matrix may include copying a data value of the element having a smaller matrix position value among the first matrix position and the second matrix position.

The generating of the third matrix based on the result of comparing the first column position value and the second column position value may include: when the first column position value is different from the second column position value, copying, to the third matrix, the element value having the smaller column position value; and when the first column position value is the same as the second column position value, summing, to the third matrix, the first element value and the second element value.

The method may further include transmitting the third matrix via the network to another network switch.

The sparse matrix storage format may include a coordinate list (COO), a compressed sparse row (CSR), an ellpack (ELL), a list of lists (LIL) format, or a diagonal (DIA) format).

The first matrix position may include a row index of the first element value, a column index of the first element value, or a row offset of the first element value.

The switch that performs the method may be an aggregation node that implements a scalable hierarchical aggregation and reduction protocol (SHARP).

The aggregation node may be an InfiniBand node participating in an InfiniBand network used by the first and second electronic devices, which are respective end nodes.

Other features and aspects will be apparent from the following detailed description, the drawings, and the claims.

### BRIEF DESCRIPTION OF THE DRAWINGS

FIG. 1 illustrates an example collective communication system using a scalable hierarchical aggregation and reduction protocol (SHARP), according to one or more embodiments.

FIG. 2 illustrates an example of sparse data, according to one or more embodiments.

FIG. 3 illustrates an example of a sparse matrix storage format, according to one or more embodiments.

FIG. 4 illustrates an example of a sparse matrix storage format, according to one or more embodiments.

FIG. 5 illustrates an example of a sparse matrix storage format, according to one or more embodiments.

FIG. 6 illustrates an example aggregation and reduction method for a coordinate list sparse matrix storage format, according to one or more embodiments.

FIG. 7 illustrates an example aggregation and reduction method for a compressed sparse row sparse matrix storage format, according to one or more embodiments.

FIG. 8 illustrates an example aggregation and reduction method for an elllpack sparse matrix storage format, according to one or more embodiments.

FIG. 9 illustrates an example aggregation and reduction method for a sparse matrix storage format, according to one or more embodiments.

FIG. 10 illustrates an example aggregation and reduction method for a sparse matrix storage format, according to one or more embodiments.

FIG. 11 illustrates an example operation of an aggregation node, according to one or more embodiments.

FIG. 12 illustrates an example operation of an aggregation node, according to one or more embodiments.

FIG. 13 illustrates an example of an operation of an end node, according to one or more embodiments.

FIG. 14 illustrates an example of an aggregation node, according to one or more embodiments.

FIG. 15 illustrates an example of an end node, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

FIG. 1 illustrates an example collective communication system using a SHARP protocol, according to one or more embodiments.

Referring to FIG. 1, a collective communication system 100 may include end nodes 110 (e.g., computing devices) and aggregation nodes 130 and 150. The aggregation nodes 130 and 150 are electronic devices and may be, for example, network switches for collective communication. Use of the SHARP protocol may reduce the volume of data moving through a network and may reduce message passing interface (MPI) work time by offloading a collective communication operation to an appropriately configured switch network (e.g., an InfiniBand network).

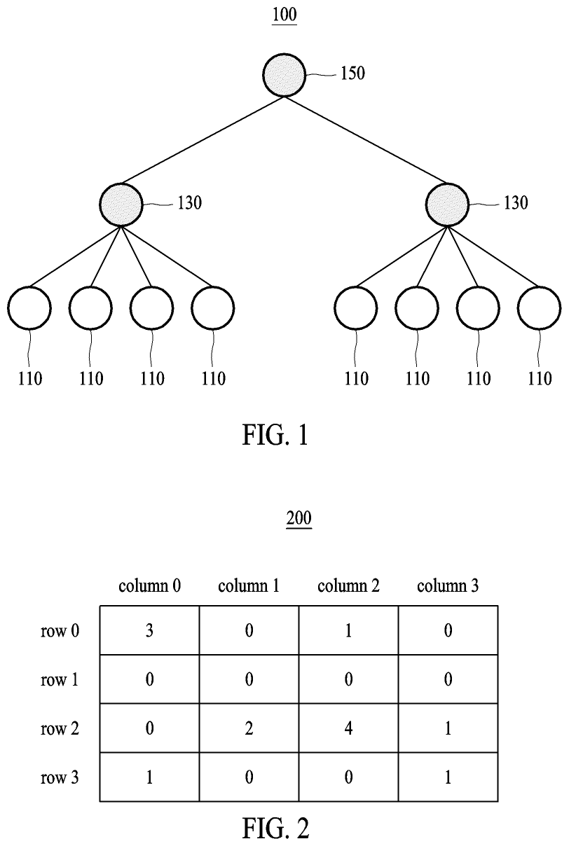

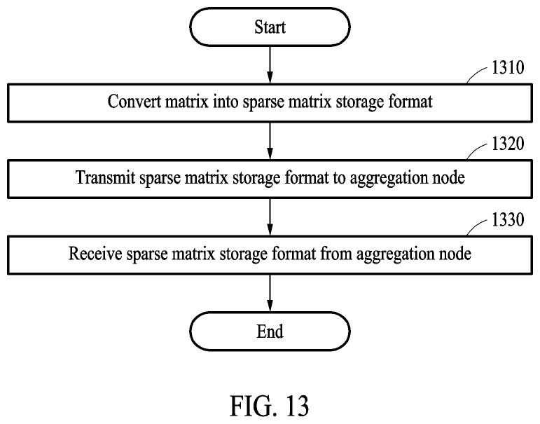

According to an example, the end nodes 110 may transit data in various formats to the aggregation node 130. For example, the end nodes 110 may transmit data in a vector format and/or a matrix format (e.g., a sparse matrix storage format). A detailed description of operations of the end nodes 100 is provided with reference to FIG. 13. The sparse matrix storage format may be efficient for transmitting sparse data (e.g., a sparse matrix). Detailed descriptions of sparse data and the sparse data storage formats are provided with reference to FIGS. 2 to 5.

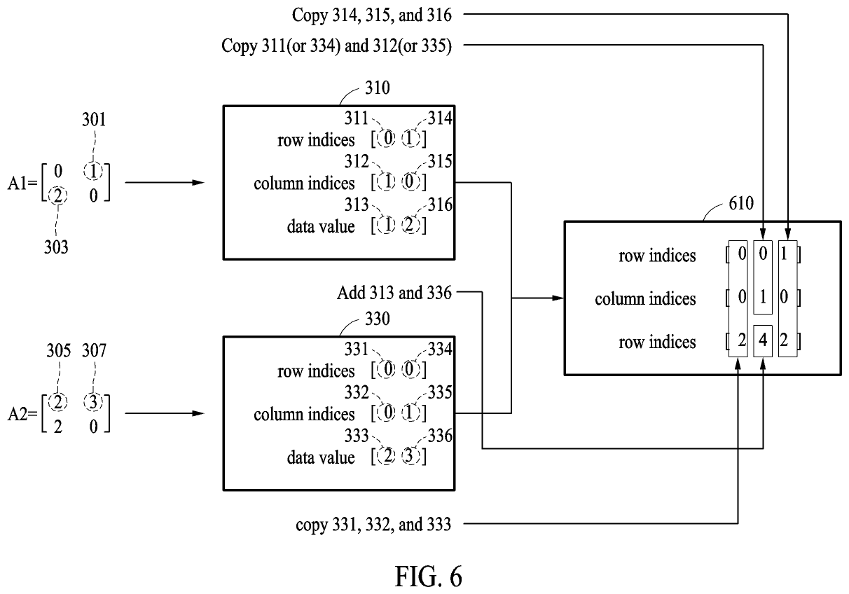

According to an example, an aggregation node 130 may perform aggregation and reduction on data received from the end nodes 110. An aggregation node 150 may perform aggregation and reduction on data received from aggregation nodes 130. Detailed description of an aggregation and reduction methods is provided with reference to FIGS. 6 to 11.

According to an example, the aggregation node 130 may transmit data obtained through aggregation and reduction (e.g., reduced data) to the end nodes 100. When there is a higher-level aggregation node 150 (e.g., a root node) in the communication system 100, the aggregation node 130 may transmit reduced data to the higher-level aggregation node 150. The higher-level aggregation node 150 may perform aggregation and reduction on data received from the aggregation node 130. Data reduced by the higher-level aggregation node 150 may be transmitted to the end nodes 110.

FIG. 2 illustrates an example of sparse data, according to one or more embodiments.

Referring to FIG. 2, data transmitted by end nodes (e.g., the end nodes 110 of FIG. 1) to an aggregation node (e.g., the aggregation node 130 of FIG. 1) may include sparse data. The sparse data may be data with a low ratio of valid (e.g., non-zero) data.

According to an example, the data to be transmitted may initially be in the form of a matrix (e.g., a matrix 200), which may also be referred to as a “dense” or “normal” matrix. A sparse dense matrix (e.g., the matrix 200) may a high have ratio of elements whose values are 0 (or some other predominant value).

According to an example, the end nodes 110 may convert the format of outgoing data (e.g., sparse data expressed by a sparse dense matrix 200) (the reverse of such conversion on incoming data may be assumed). For example, the end nodes 110 may convert the format of the data into a sparse matrix storage format (e.g., a coordinate list (COO), a compressed sparse row (CSR), a compressed sparse column (CSC), an ellpack (ELL), a list of lists (LIL), and/or a diagonal (DIA) format). The end nodes 110 may transmit thus-converted matrices having a sparse matrix storage format to aggregation nodes 130.

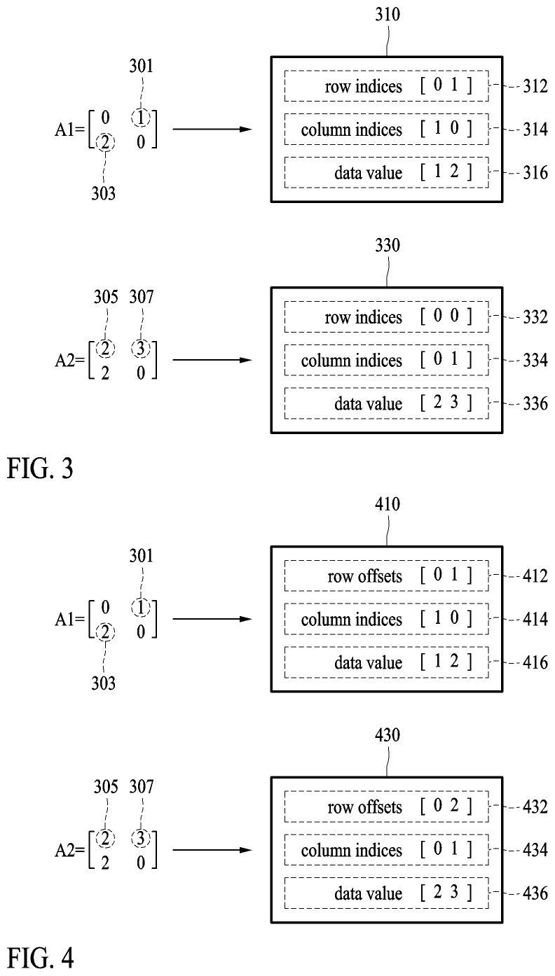

FIGS. 3 to 5 illustrate an example of a sparse matrix storage format, according to one or more embodiments.

Referring to FIG. 3, according to an example, end nodes (e.g., the end nodes 130 of FIG. 1) may convert matrices (e.g., sparse matrices A1 and A2) into COOs (e.g., COOs 310 and 330). The COOs 310 and 330 may include data/element values 316 and 336 and position information 312, 314, 332, and 334 of elements 301-307 having non-zero data values among elements of the sparse dense/normal matrices A1 and A2. For example, the COOs 310 and 330 may include values 312 and 332 (e.g., row indices) for positions of rows of the elements 301 to 307 and values 314 and 334 (e.g., column indices) for positions of columns of the elements 301 to 307.

Referring to FIG. 4, according to an example, end nodes (e.g., the end nodes 110 of FIG. 1) may convert normal/dense matrices (e.g., the sparse matrices A1 and A2) into CSRs (e.g., CSRs 410 and 430). The CSRs 410 and 430 may include data/element values 416 and 436 and position information 412, 414, 432, and 434 of the elements 301 to 307 having non-zero values among elements of the sparse matrices A1 and A2. For example, the CSRs 410 and 430 may include values 412 and 432 (e.g., row offsets) for start positions of rows of elements 301-307 and values 414 and 434 (e.g., column indices) for positions of columns of the elements 301-307.

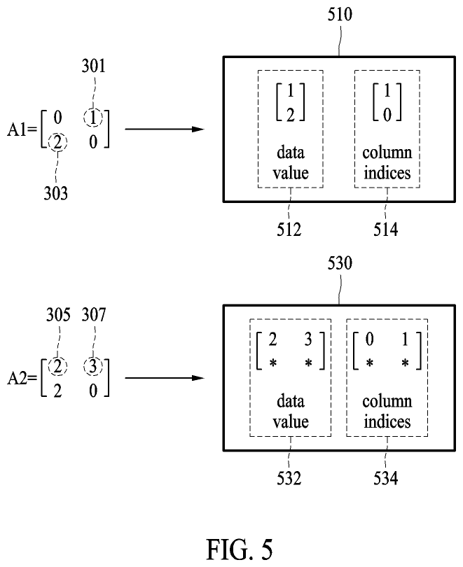

Referring to FIG. 5, according to an example, end nodes (e.g., the end nodes 110 of FIG. 1) may convert dense/normal matrices (e.g., the sparse matrices A1 and A2) into ELLs (e.g., ELLs 510 and 530). The ELLs 510 and 530 may include data/element values 512 and 532 and position information 514 and 534 of elements 301 to 307 having non-zero data values among elements of the sparse dense/normal matrices A1 and A2. The number of columns of the ELLs 510 and 530 may be determined based on a row having the most non-zero values among rows of the sparse matrices A1 and A2.

According to an example, the sparse matrix storage formats 310, 330, 410, 430, 510, and 530 illustrated in FIGS. 3 to 5 are only examples and the scope of the present disclosure is not limited thereto.

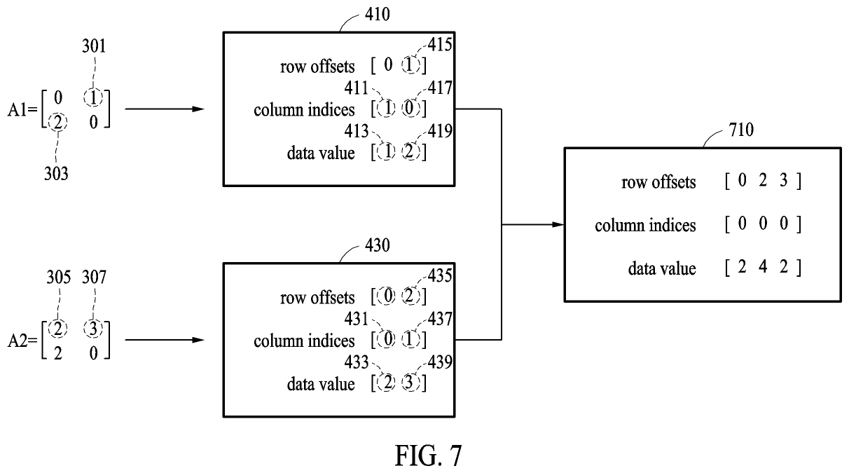

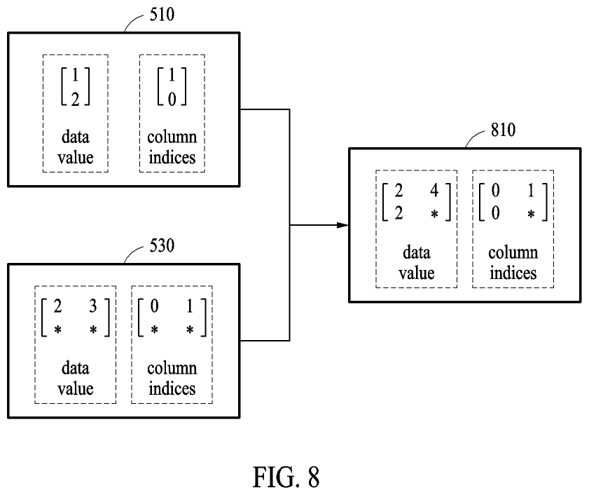

FIGS. 6 to 8 illustrate examples of aggregation and reduction methods for sparse matrix storage formats, according to one or more embodiments. FIG. 6 illustrates an aggregation and reduction method for a COO. FIG. 7 illustrates an aggregation and reduction method for a CSR. FIG. 8 illustrates an example of a reduction method for an ELL. The aggregation and reduction methods may be performed by any of the aggregation nodes such as aggregation nodes 130 or 150. In some embodiments, the aggregation involves adding matrices in a same sparse storage form.

Referring to FIG. 6, an aggregation node performs aggregation and reduction on the COOs 310 and 330. The aggregation node may obtain a COO 610 by performing aggregation and reduction on the COOs 310 and 330. The COO 610 is a result of adding COO 310 with COO 330. As described below with reference to FIG. 6, in effect, the aggregation node compares the indices (i.e., matrix positions) of one input COO with the indices of the other input COO. When an index is determined to be unique to either input COO, that index and its corresponding data/element value are copied from the corresponding input COO to the aggregation/result COO. When an index is determined to not be unique, i.e., the index is not found in both input CODs, then (i) that index is copied to the aggregation/result COO and, (ii) the data values corresponding to that non-unique index in the input COOs are added and the result is set as the data value for that non-unique index copied to the aggregation/result COO.

The aggregation node (e.g., aggregation node 130 or 150) may perform reduction (by aggregation/addition) based on position/index information of the elements 301-307 of the sparse matrix format representations (CODs) of matrices A1 and A2. That is, the aggregation node receiving the COOs 310 and 330 may perform reduction thereof based on row positions of the elements 301-307 and column positions of the elements 301-307. Specifically, as noted, the aggregation node may perform reduction by comparing row position values 311, 314, 331, and 334 (e.g., row indices) to column position values 312, 315, 332, and 335 (e.g., column indices). Hereinafter, for ease of description, the description is provided with an example of the COOs 310 and 330 for the matrices A1 and A2 (although index values of only 0 and 1 are shown in this example, index/position values may be larger than 1 for larger sparse matrices).

According to an example, the aggregation node may perform a comparison between the elements 301 and 307 (as represented in the COOs 310 and 330) in an order based on the positions of rows of the elements 301 to 307 of the matrices A1 and A2 having non-zero data values (i.e., in an index order).

The aggregation node may compare the row position value 311 (e.g., a row index) of the element 301 to the row position value 331 (e.g., a row index) of the element 305. When the row position value 311 is the same as the corresponding row position value 331, the aggregation nodes 130 and 150 may compare the column position value 312 (e.g., a column index) of the element 301 and the column position value 332 (e.g., a column index) of the element 305. Having determined non-uniqueness, the aggregation node may copy an element data value (e.g., the data value 333) and its index/position (e.g., row and column position values 331 and 332) of the element 305 determined to have the smaller column position (e.g., the smaller of the column position values 312 and 332). Although not illustrated in FIG. 6, when the row position value 311 of the row of the element 301 is different from the row position value 331 of the row of the element 305, the aggregation nodes 130 and 150 may copy a data value and position information of an element having the smaller value of the row position values 311 and 331.

Continuing the example of FIG. 6, after a reduction operation on the element 305 is completed, the aggregation nodes 130 and 150 may compare the row position value 311 of the element 301 to the row position value 334 of the row of the element 307. When the row position value 311 is the same as the row position value 334, the aggregation node may compare the column position value 312 of the element 301 to the column position value 335 of the column of the element 305; when they are the same, the aggregation node may copy to the COO 610 (i) the index of the elements 301 and 307 (which is the same for both), i.e., the row position value 311 (or 331) and column position value 312 (or 332), and (ii) a sum of the data values 313 and 336 (of the elements 301 and 307) as the data value for the copied index.

According to an example, when an aggregation/reduction operation on the elements 301 and 307 is completed, the aggregation node may copy the data value 316 and the position information 314 and 315 of the element 303; as there is no element in COO 330 that has the same position as the element 303, the aggregation node may copy element 303's data value 316 and the position information 314 and 315 without any sum operation.

To summarize, the aggregation node (e.g., aggregation node 130 or 150) may receive matrices in sparse matrix storage formats (i.e., COOs 310 and 330 for the matrices A1 and A2) from end nodes (e.g., the end nodes 110 of FIG. 1) and may perform aggregation and reduction suitable to the sparse matrix storage formats by (i) copying unique positions (and their data values) to the result matrix and by (ii) combining (e.g. adding) data values having a same position in both matrices and copying the addition result and the same position to the result matrix. Accordingly, the aggregation nodes 130 and 150 may reduce a bottleneck of collective communication by performing aggregation and reduction on received matrices according to their sparse matrix storage format. In addition, the aggregation nodes 130 and 150 may benefit an artificial intelligence (AI) application of a multi-node environment and/or may provide an energy-efficient computing method for an application associated with sparse data.

FIG. 7 illustrates an aggregation and reduction method for a CSR, according to one or more embodiments.

Referring to FIG. 7, an aggregation node (e.g., the aggregation node 130 or 150) may perform aggregation and reduction on CSRs 410 and 430. The aggregation node may obtain a result CSR 710 by performing aggregation and reduction on the inputted/received CSRs 410 and 430. The reduction method for the CSRs 410 and 430 may be substantially the same as the reduction method for the COOs 310 and 330 (some differences are described next). A repeated description is omitted and following is a description of using a counter for reduction of the CSRs 410 and 430 is provided.

According to an example, since the received CSRs 410 and 430 do not include row position values of the elements 301 to 307 (instead using row offsets), the aggregation node may use a counter (e.g., a program counter) for reduction of the CSRs 410 and 430. The counter may be implemented with a register.

According to an example, the counter may count reduction operations for the respective CSRs 410 and 430. For example, the aggregation node may compare the row position value 411 of the element 301 to the row position value 431 of the element 305. The aggregation node may copy a data value 433 of the element 305 having the position value 431 and may set a value of the counter for the CSR 430 to 1. The aggregation node may perform a reduction operation on the elements 301 to 307 of the matrices A1 and A2 (as represented in the CSRs 410 and 430) and may change the value of the counter. When value of counters for the CSRs 410 and 430 are the same as row offsets 415 and 435 of the CSRs 410 and 430, the aggregation nodes 130 and 150 may determine that the reduction operation on the CSRs 410 and 430 is complete.

FIG. 8 illustrates an example of a reduction method for an ELL, according to one or more embodiments.

Referring to FIG. 8, an (e.g., aggregation node 130 or 150) may perform aggregation and reduction on ELLs 510 and 530. The aggregation node may obtain an ELL 810 by performing aggregation and reduction on the received ELLs 510 and 530. With the exception of ELL-specific details for iterating and comparing over the ELLs 510 and 530, the reduction method for the ELLs 510 and 530 may be substantially the same as the reduction method for the COOs 310 and 330.

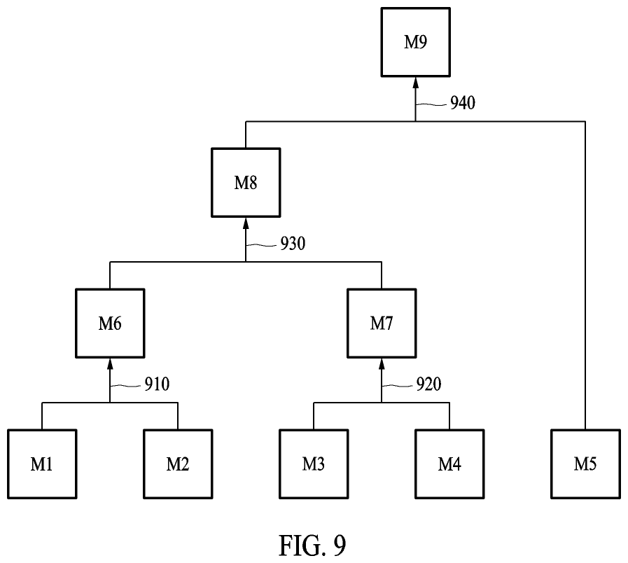

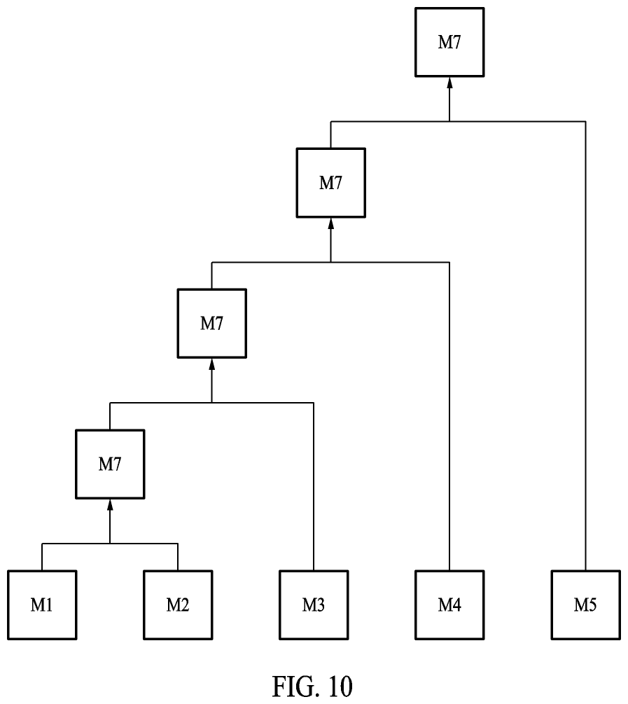

FIGS. 9 and 10 illustrate an example of an aggregation and reduction method for a sparse matrix storage format, according to one or more embodiments. The examples of FIGS. 9 and 10 show a tree of aggregation and consolidation of sparse matrix representations (matrices in a sparse matrix format). The trees shown in FIGS. 9 and 10 may or may not correspond to aggregation nodes and their connections. That is, the examples in FIGS. 9 and 10 can be implemented by different arrangements of aggregation nodes. For example, the tree structures in FIGS. 9 and 10 can also represent a tree structure of aggregation nodes. The tree structures may also represent the actions of one or a few aggregation nodes, or different connectivity structures. For example, each of M1 to M5 might correspond to different respective aggregation nodes 130, M6 to M9 might represent one aggregation node 150, or may represent respective aggregation nodes 150. For discussion, a one-to-one correspondence between the boxes in FIGS. 9 and 10 and aggregation nodes will be assumed. However, it is possible that a single aggregation node may receive multiple sparse matrices (in sparse format) and perform multiple levels of aggregation and reduction. For example, it is possible that a single aggregation node 150 receives M6, M7 and M6, aggregates M6 and M7 to generate M8, and aggregates M8 and M5 to generate M9.

FIG. 9 illustrates an example of an aggregation and reduction method for sparse matrices M1 to M5 formatted in a sparse matrix storage format (e.g., any of the formats described above, or another suitable format).

Referring to FIG. 9, first aggregation nodes (e.g., instances of the aggregation node 130) may receive matrices in the form of the sparse matrix storage formats M1 to M5 (e.g., the formatted sparse matrices 310, 330, 410, 430, 510, and 530 of FIGS. 3 to 8) from respective end nodes (e.g., the end nodes 110 of FIG. 1).

According to an example, operations 910 to 940 may be performed sequentially but are not limited thereto. For example, the order of operations 910 and 920 may change. In another example, operations 910 and 920 may be performed in parallel.

In operation 910, a first aggregation node may generate a sparse matrix M6 through aggregation and reduction on the sparse matrices M1 and M2 (in a sparse matrix format). The aggregation and reduction method for the sparse matrices M1 and M2 may be substantially the same as any of the methods described with reference to FIGS. 6 to 8. In some implementations, it may be possible for an aggregation node to aggregate and reduce two matrices having two different sparse matrix formats. In this case, the aggregation node may convert a first of the matrices from its original sparse matrix format to the sparse matrix format of the second matrix, and the two matrices may then be aggregated and reduced.

In operation 920, another first aggregation node may similarly generate a sparse matrix M7 (of the same format as M1 and M2) through aggregation and reduction on the sparse matrices M3 and M4.

In operation 910, a second aggregation node (e.g. an instance of an aggregation node 150) may generate a sparse matrix M8 (of the same sparse format as M6 and M7) through aggregation and reduction on the sparse matrices M6 and M7.

In operation 910, a third aggregation node may obtain a sparse matrix storage format M9 through aggregation and reduction on the sparse matrix storage formats M5 and M8.

According to an example, the aggregation nodes 130 and 150 may perform aggregation and reduction in various methods on the matrices M1 to M5. For example, the aggregation nodes 130 and 150 may perform aggregation and reduction on the plurality of matrices M1 to M5 in the method illustrated in FIG. 10. The reduction methods illustrated in FIGS. 9 and 10 are examples of aggregation and reduction of sparse matrices M1 to M5 (in sparse matrix storage format(s)), and the scope of the present disclosure is not limited thereto.

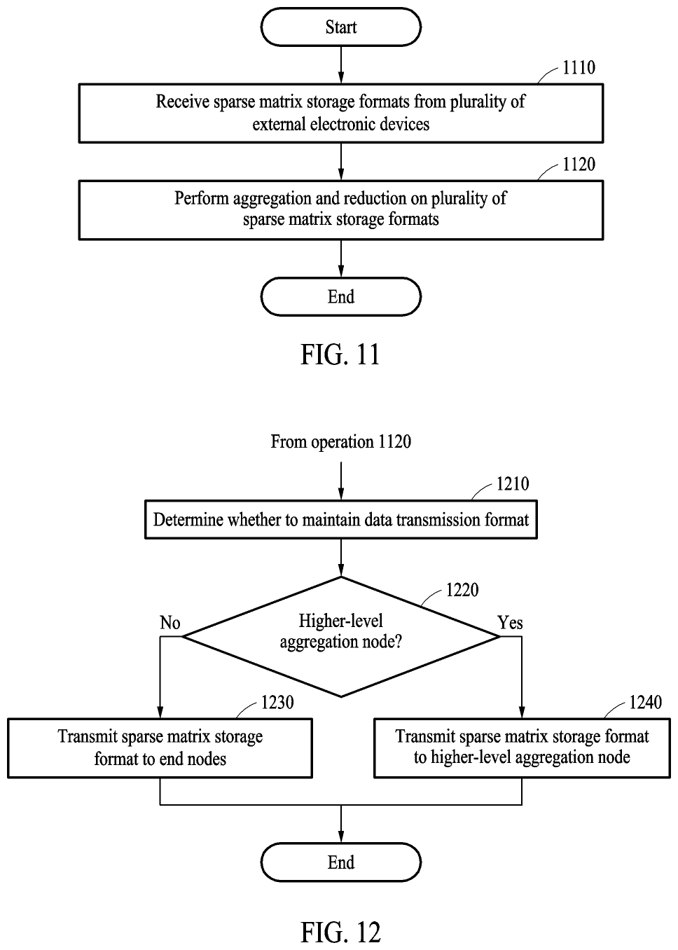

FIG. 11 illustrates an example operation of an aggregation node. More specifically, FIG. 11 illustrates an example of an aggregation and reduction operation of an aggregation node (e.g., any of the aggregation nodes 130 and 150 of FIG. 1).

Referring to FIG. 11, operations 1110 and 1120 may be performed sequentially but are not limited thereto. For example, operations 1110 and 1120 may be performed in parallel.

In operation 1110, the aggregation node may receive any one of sparse matrices in any sparse matrix storage format (e.g., any of the sparse matrices M1 to M5 of FIGS. 9 and 10) from each of a plurality of external electronic devices (e.g., the end nodes 110 of FIG. 1). Any of the sparse matrices M1 to M5 may have any sparse matrix storage format, for example COO (e.g., the COOs 310 and 330 of FIGS. 3 and 6), CSR (e.g., the CSRs 410 and 430 of FIGS. 4 and 7), ELL (e.g., the ELLs 510 and 530 of FIGS. 5 and 8), CSC (not illustrated), LIL (not illustrated), and/or DIA (not illustrated).

In operation 1120, the aggregation node may perform aggregation and reduction on the sparse matrices M1 to M5 received from the end nodes 110. The aggregation and reduction method(s) applied to the sparse matrices M1 to M5 may be substantially the same as any of the aggregation and reduction methods described with reference to FIGS. 6 to 10.

According to an example, the aggregation nodes 130 and 150 may reduce a bottleneck of collective communication by performing aggregation and reduction on the sparse matrices in any sparse matrix storage format.

According to an example, the aggregation nodes 130 and 150 may provide an AI application of a multi-node environment and/or an energy-efficient computing method for an application associated with sparse data. Although the example matrices described above are trivially small (for ease of understanding), in practice the matrices may be orders of magnitude larger and the efficiency gains of aggregation/reduction may be substantial.

FIG. 12 illustrates an example operation of an aggregation node. More specifically, FIG. 12 illustrates an example of a data transmission operation of an aggregation node (e.g., the aggregation nodes 130 and 150 of FIG. 1).

Referring to FIG. 12, according to an example, operations 1210 to 1240 may be sequentially performed but are not limited thereto. For example, the order of operations 1210 and 1220 may change. In another example, operations 1210 and 1220 may be performed in parallel.

In operation 1210, the aggregation node may determine whether to maintain a data transmission format for collective communication having a sparse matrix storage format (e.g., any one of the sparse matrix storage formats 310, 330, 410, 430, 510, and 530 of FIGS. 3 to 8). For example, the aggregation node may determine whether to maintain the data transmission format based on sparsity of a matrix that is in a sparse matrix storage format (e.g., the sparse matrix M9 of FIGS. 9 and 10) obtained through aggregation and reduction. When a decrease in the sparsity is greater than or equal to a threshold (or when an overall sparsity of the matrix or a ratio of the sparsity is above a threshold), the aggregation nodes 130 and 150 may determine to transform the matrix from the data transmission format having the sparse matrix storage format to a matrix having a dense (e.g., full/normal) format. The aggregation node may calculate the sparsity of the matrix using a capacity of the normal/dense matrix corresponding to the sparse matrix storage format M9. In some implementations, a ratio of the size of the sparse matrix to the size of the represented matrix (the matrix if represented in-full) may be used to determine whether to reformat the matrix to a non-sparse format.

According to an example, when it has been determined at operation 1210 that the matrix is to be reformatted from a sparse matrix format to an ordinary/dense matrix, the aggregation node may transmit, to end node(s) (e.g., the end nodes 110 of FIG. 1) a change signal for changing the data transmission format. For example, the aggregation node may transmit, to the end nodes 110, the change signal and an indication of the sparse matrix storage format (e.g., the sparse matrix storage format transmitted in operation 1230) obtained through aggregation and reduction.

According to an example, the aggregation node may improve the data transmission efficiency of collective communication by changing the data transmission format based on the sparsity of the matrix.

In operation 1220, the aggregation node may determine whether a higher-level aggregation node exists. For example, aggregation node 130 may determine whether the higher-level aggregation node 150 exists.

In operation 1230, when there is no higher-level aggregation node, the aggregation node (e.g., the aggregation node 150) may transmit the indication of the sparse matrix storage format (obtained through aggregation and reduction) to one or more of the end nodes 110. For example, the matrix M9 may be transmitted to the end node(s) 110 through the aggregation node 130.

In operation 1240, when the higher-level aggregation node (e.g., the aggregation node 150) exists, the aggregation node 130 (e.g., the aggregation node 130) may transmit the indication of the sparse matrix storage format to the higher-level aggregation node 150.

To summarize, an aggregation node may determine that a matrix in a sparse storage format (that has been formed by aggregation and reduction) may not be sufficiently sparse to justify the sparse storage format (e.g., the matrix has so many non-zero elements that the matrix is larger in the sparse storage format than it would be as an ordinary matrix). The aggregation node may inform upstream and/or downstream nodes (end nodes or aggregation nodes, as the case may be) of a need to change the format of the matrix. Those other nodes may adjust accordingly. In addition, the aggregation node may reformat the matrix from the sparse storage format to an ordinary matrix format before transmitting the matrix upstream or downstream to another node (aggregation node or end node).

FIG. 13 illustrates an example operation of an end node.

Referring to FIG. 13, according to an example, operations 1310 to 1330 may be sequentially performed but are not limited thereto. For example, two or more operations may be performed in parallel.

In operation 1310, end nodes (e.g., the end nodes 110 of FIG. 1) may change any one of normal/dense matrices (e.g., the matrices A1 and A2 of FIGS. 3 to 7) of data to a sparse matrix storage format. For example, the end nodes 110 may change a matrix (e.g., any one of the matrices A1 and A2) to any one of COO (e.g., the COOs 310 and 330 of FIGS. 3 and 6), CSR (e.g., the CSRs 410 and 430 of FIGS. 4 and 7), ELL (e.g., the ELLs 510 and 530 of FIGS. 5 and 8), CSC (not illustrated), LIL (not illustrated), and DIA (not illustrated).

In operation 1320, the end nodes 110 may transmit the matrix in the sparse matrix storage format to an aggregation node (e.g., the aggregation node 130 of FIG. 1).

In operation 1330, the end nodes 110 may receive a matrix in a sparse matrix storage format (e.g., the matrix M9 of FIGS. 9 and 10), which has been obtained/generated through aggregation and reduction of the aggregation node(s), from the aggregation node 130. When a change signal (e.g., the change signal transmitted in operation 1210 of FIG. 12) for a data transmission format is received, the end nodes 110 may instead transmit data of a matrix format (e.g., a dense format) to the aggregate node 130.

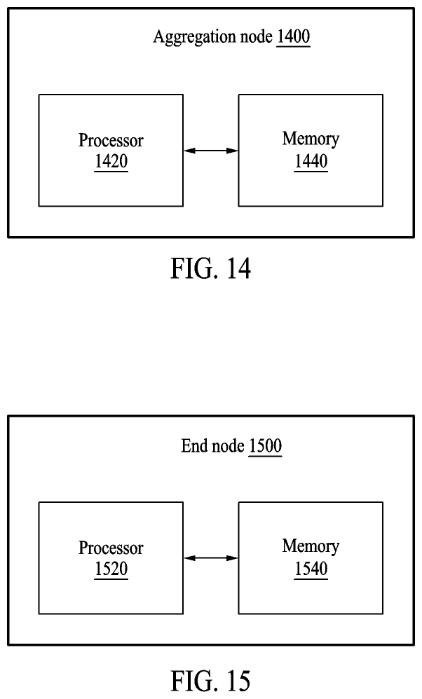

FIG. 14 illustrates an example of an aggregation node 1400. The aggregation node 1400 (e.g., the aggregation nodes 130 and 150 of FIG. 1) may be an electronic device (e.g., a network switch). According to an example, the aggregation node 1400 may include a memory 1440 and a processor 1420.

The memory 1440 may store instructions (or programs) executable by the processor 1420. For example, the instructions may include instructions for performing the operation of the processor 1420 and/or an operation of each component of the processor 1420.

The processor 1420 may process data stored in the memory 1440. The processor 1420 may execute computer-readable code (e.g., software) stored in the memory 1440 and instructions triggered by the processor 1420.

The processor 1420 may be a hardware-implemented data processing device having a circuit that is physically structured to execute desired operations. For example, the desired operations may include code or instructions included in a program.

The hardware-implemented data processing device may include, for example, a microprocessor, a central processing unit (CPU), a processor core, a multi-core processor, a multiprocessor, an ASIC, and an FPGA.

An operation performed by the processor 1420 may be substantially the same as the operation of the aggregation nodes 130 and 150 described with reference to FIGS. 1 and 3 to 12. Accordingly, a detailed description thereof is omitted.

FIG. 15 illustrates an example of an end node 1500. The end node 1500 (e.g., any one of the end nodes 110 of FIG. 1) may be an electronic device (e.g., a computing device). According to an example, the end node 1500 may include a memory 1540 and a processor 1520.

The memory 1540 may store instructions (or programs) executable by the processor 1520. For example, the instructions may include instructions for performing the operation of the processor 1520 and/or an operation of each component of the processor 1520.

The processor 1520 may process data stored in the memory 1540. The processor 1520 may execute computer-readable code (e.g., software) stored in the memory 1540 and instructions triggered by the processor 1520.

The processor 1520 may be a hardware-implemented data processing device having a circuit that is physically structured to execute desired operations. For example, the desired operations may include code or instructions included in a program.

The hardware-implemented data processing device may include, for example, a microprocessor, a CPU, a processor core, a multi-core processor, a multiprocessor, an ASIC, and an FPGA.

An operation performed by the processor 1520 may be substantially the same as the operation of the end nodes 110 described with reference to FIGS. 1 and 13. Accordingly, a detailed description thereof is omitted.

The computing apparatuses, the electronic devices, the processors, the memories, the information output system and hardware, the storage devices, and other apparatuses, devices, units, modules, and components described herein with respect to FIGS. 1-15 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-15 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A network switch for collective communication, the network switch comprising:
one or more processors electrically connected with a memory;
the memory storing instructions configured to, when executed by the one or more processors, cause the one more processors to:
receive first and second matrices via a network from respective external electronic devices, the first and second matrices each having a sparse matrix storage format; and
generate a third matrix in the sparse matrix storage format from the received first and second matrices by aggregating the received first and second matrices into the third matrix according to the sparse matrix storage format.

2. The network switch of claim 1, wherein the generating comprises:
comparing a first position of a first element in the first matrix having a non-zero data value to a second position of a second element in the second matrix having a non-zero data value; and
generating the third matrix from the first matrix and the second matrix based on a result of comparing the first position and the second position.

3. The network switch of claim 2, wherein the comparing of the first position to the second position comprises comparing a first row position value of the first position to a second row position value of the second position, and
wherein the generating the third sparse matrix is based on a result of comparing the first row position value and the row second position value.

4. The network switch of claim 3, wherein the comparing of the first position to the second position further comprises, when the row first position value is the same as the second row position value, comparing a first column position value of the first position to a second column position value of the second position, and
wherein the generating of the third matrix is based on result of comparing the first column position value and the second column position value.

5. The network switch of claim 3, wherein the generating of the third matrix comprises copying, to the third matrix, a data value of the element having the smaller row position value among the first row position value and the second row position value.

6. The network switch of claim 4, wherein the generating the third matrix based on the result of comparing the first column position value and the second column position value comprises:
when the first column position value is different from the second column position value, copying a data value of the element having the smaller column position value among the first column position value and the second column position value; and
when the first column position value is the same as the second column position value, adding the data value of the first element to the data value of the second element.

7. The network switch of claim 1, wherein the instructions are further configured to cause the one or more processors to:
transmit the generated matrix via the network to one of the external electronic devices.

8. The network switch of claim 1, wherein the sparse matrix storage format comprises a coordinate list (COO) format, a compressed sparse row (CSR) format, and an ellpack (ELL) format, a list of lists (LIL) format, or a diagonal (DIA) format).

9. The network switch of claim 8, wherein the first position comprises a row index of the first element, a column index of the first element, or a row offset for the first element.

10. A method of operating a network switch for collective communication, the method comprising:
receiving, via a network from external electronic devices, a first and second matrix each formatted according to a sparse matrix storage format; and
generating a third matrix formatted according to the sparse matrix storage format, wherein the third matrix is generated by combining the first and second matrix according to the sparse matrix storage format, wherein, according to the sparse matrix storage format the first matrix comprises first matrix positions of respective first element values and the second matrix comprises second matrix positions of respective second element values, and wherein the combining comprises comparing the first matrix positions with the second matrix positions.

11. The method of claim 10, wherein the generating comprises:
comparing a first matrix position of a first element value to a second matrix position of a second element value; and
based on the first matrix position and the second matrix position being equal, adding to the third matrix, as a new matrix position thereof, the first or second matrix position, and adding, as a new element value of the new matrix position of the third matrix, a sum of the first element value and the second element value.

12. The method of claim 11, wherein the comparing of the first matrix position to the second matrix position comprises comparing a first row position value of the first matrix position to a second row position value of the second matrix position, and
wherein the generating the third matrix is based on a result of comparing the first row position value and the second row position value.

13. The method of claim 12,
wherein when the first row position value is the same as the second row position value, comparing a first column position value of the first matrix position a second column position value of the second matrix position, and
wherein the generating the third matrix is based on a result of the comparing of the first column position value and the second column position value.

14. The method of claim 12, wherein the generating of the third matrix comprises copying a data value of the element having a smaller matrix position value among the first matrix position and the second matrix position.

15. The method of claim 13, wherein the generating of the third matrix based on the result of comparing the first column position value and the second column position value comprises:
when the first column position value is different from the second column position value, copying, to the third matrix, the element value having the smaller column position value; and
when the first column position value is the same as the second column position value, summing, to the third matrix, the first element value and the second element value.

16. The method of claim 10, further comprising:
transmitting the third matrix via the network to another network switch.

17. The method of claim 10, wherein the sparse matrix storage format comprises a coordinate list (COO), a compressed sparse row (CSR), an ellpack (ELL), a list of lists (LIL) format, or a diagonal (DIA) format).

18. The method of claim 17, wherein the first matrix position comprises a row index of the first element value, a column index of the first element value, or a row offset of the first element value.

19. The method of claim 10, wherein the switch that performs the method is an aggregation node that implements a scalable hierarchical aggregation and reduction protocol (SHARP).

20. The method of claim 19, wherein the aggregation node comprises an InfiniBand node participating in an InfiniBand network used by the first and second electronic devices, which are respective end nodes.
